(19) United States
(12) Patent Application Publication
(10) Pub. No.: US 2023/0004886 A1
(43) Pub. Date: Jan. 5, 2023

(54) SYSTEMS AND METHODS FOR PERFORMING EXPERIMENTS AT REMOTE LABORATORIES

(71) Applicant: STRATEOS, INC., Menlo Park, CA (US)

(72) Inventors: Vanessa Biggers, San Francisco, CA (US); Sayagoud Ramu Phanimukla, Peasanton, CA (US); Venkat Eswarakrishnan, Fremont, CA (US); Alok Gupta, San Ramon, CA (US); Abhishek Kumar, Dublin, CA (US); Eriberto Lopez, Costa Mesa, CA (US); Benjamin Nicholas Miles, San Francisco, CA (US); Joshua David Nowak, San Jose, CA (US); Rickin Pankaj Patel, Elk Grove, CA (US)

(21) Appl. No.: 17/854,724

(22) Filed: Jun. 30, 2022

Related U.S. Application Data
(60) Provisional application No. 63/218,265, filed on Jul. 2, 2021.
(60) Provisional application No. 63/218,267, filed on Jul. 2, 2021.
(60) Provisional application No. 63/218,272, filed on Jul. 2, 2021.
(60) Provisional application No. 63/218,274, filed on Jul. 2, 2021.

(51) Int. Cl. G06Q 10/06

(52) U.S. Cl. CPC G06Q 10/0633; G06Q 10/06316

(57) ABSTRACT

System and method for performing experiments. For example, the method includes receiving indications of experimental workflows, generating workflow configuration requirements for each experimental workflow, configuring each experimental workflow based upon parameters associated with the workflow configuration requirements, receiving experimental requests for the experimental workflows, determining a schedule for executing the experimental requests, assigning each experimental request one or more remote laboratories for execution based upon the schedule, generating a set of instructions for performing experiments related to each experimental request, determining a plurality of sequence schedules for completing the set of instructions, receiving an indication of a sequence schedule selected from the plurality of sequence schedules, and transmitting commands to execute the set of instructions according to the selected sequence schedule.

### CROSS-REFERENCE TO RELATED APPLICATIONS

This application claims priority to U.S. Provisional Patent Application No. 63/218,265, filed Jul. 2, 2021, U.S. Provisional Patent Application No. 63/218,267, filed Jul. 2, 2021, U.S. Provisional Patent Application No. 63/218,272, filed Jul. 2, 2021, and U.S. Provisional Patent Application No. 63/218,274, filed Jul. 2, 2021, all of which are incorporated by reference herein for all purposes.

The following four applications, including this one, are being filed concurrently and the other applications are hereby incorporated by reference in their entirety for all purposes:

1. U.S. patent application Ser. No. ______, titled “Systems and Methods for Processing Experimental Workflows at Remote Laboratories” (Attorney Docket Number 520295.000014); and

2. U.S. patent application Ser. No. ______, titled “Systems and Methods for Managing Experimental Requests at Remote Laboratories” (Attorney Docket Number 520295.000015).

3. U.S. patent application Ser. No. ______, titled “Systems and Methods for Processing Experimental Requests at Remote Laboratories” (Attorney Docket Number 520295.000016).

4. U.S. patent application Ser. No. ______, titled “Systems and Methods for Performing Experiments at Remote Laboratories” (Attorney Docket Number 520295.000017).

### FIELD OF THE DISCLOSURE

Some embodiments of the present disclosure are directed to performing experiments. More particularly, certain embodiments of the present disclosure provide systems and methods for receiving experimental requests and generating instructions for performing experiments related to the experimental request. Merely by way of example, the present disclosure has been applied to transmitting commands to execute the instructions at remote laboratories. But it would be recognized that the present disclosure has much broader range of applicability.

### BACKGROUND OF THE DISCLOSURE

Experiments performed at designated laboratories are limited by existing infrastructure. Remote laboratories, on the other hand, provide the opportunity to carry out different experiments with different scope at the same time. Accordingly, there exists a need to develop techniques that can enable users to scale to remote laboratory infrastructures when needing capability and/or capacity.

### BRIEF SUMMARY OF THE DISCLOSURE

Some embodiments of the present disclosure are directed to performing experiments. More particularly, certain embodiments of the present disclosure provide systems and methods for receiving experimental requests and generating instructions for performing experiments related to the experimental request. Merely by way of example, the present disclosure has been applied to transmitting commands to execute the instructions at remote laboratories. But it would be recognized that the present disclosure has much broader range of applicability.

According to certain embodiments, a method for performing one or more experiments includes receiving one or more indications of one or more experimental workflows and generating workflow configuration requirements for each experimental workflow of the one or more experimental workflows. Also, the method includes configuring each experimental workflow of the one or more experimental workflows based at least in part upon one or more parameters associated with the workflow configuration requirements. Further, the method includes receiving one or more experimental requests for the one or more experimental workflows and determining a schedule for executing the one or more experimental requests based at least in part upon one or more attributes associated with the one or more experimental requests. Moreover, the method includes assigning each experimental request of the one or more experimental requests to one or more remote laboratories for execution based at least in part upon the schedule. Also, the method includes generating a set of instructions for performing one or more experiments related to each experimental request of the one or more experimental requests at the one or more remote laboratories. Further, the method includes determining a plurality of sequence schedules for completing the set of instructions and receiving an indication of a sequence schedule selected from the plurality of sequence schedules. In addition, the method includes transmitting one or more commands to execute the set of instructions according to the selected sequence schedule.

According to some embodiments, a system for performing one or more experiments includes one or more processors and a memory storing instructions for execution by the one or more processors. The instructions, when executed by the one or more processors, cause the system to receive one or more indications of one or more experimental workflows and generate workflow configuration requirements for each experimental workflow of the one or more experimental workflows. Also, the instructions, when executed by the one or more processors, cause the system to configure each experimental workflow of the one or more experimental workflows based at least in part upon one or more parameters associated with the workflow configuration requirements. Further, the instructions, when executed by the one or more processors, cause the system to receive one or more experimental requests for the one or more experimental workflows and determine a schedule for executing the one or more experimental requests based at least in part upon one or more attributes associated with the one or more experimental requests. Moreover, the instructions, when executed by the one or more processors, cause the system to assign each experimental request of the one or more experimental requests to one or more remote laboratories for execution based at least in part upon the schedule. Also, the instructions, when executed by the one or more processors, cause the system to generate a set of instructions for performing one or more experiments related to each experimental request of the one or more experimental requests at the one or more remote laboratories. Further, the instructions, when executed by the one or more processors, cause the system to determine a plurality of sequence schedules for completing the set of instructions and receive an indication of a sequence schedule selected from the plurality of sequence schedules. In addition, the instructions, when executed by the one or more processors, cause the system to transmit one or more commands to execute the set of instructions according to the selected sequence schedule.

According to certain embodiments, a non-transitory computer-readable medium stores instructions for performing one or more experiments. The instructions are executed by one or more processors of a computing device. The non-transitory computer-readable medium includes instructions to receive one or more indications of one or more experimental workflows and generate workflow configuration requirements for each experimental workflow of the one or more experimental workflows. Also, the non-transitory computer-readable medium includes instructions to configure each experimental workflow of the one or more experimental workflows based at least in part upon one or more parameters associated with the workflow configuration requirements. Further, the non-transitory computer-readable medium includes instructions to receive one or more experimental requests for the one or more experimental workflows and determine a schedule for executing the one or more experimental requests based at least in part upon one or more attributes associated with the one or more experimental requests. Moreover, the non-transitory computer-readable medium includes instructions to assign each experimental request of the one or more experimental requests to one or more remote laboratories for execution based at least in part upon the schedule. Also, the non-transitory computer-readable medium includes instructions to generate a set of instructions for performing one or more experiments related to each experimental request of the one or more experimental requests at the one or more remote laboratories. Further, the non-transitory computer-readable medium includes instructions to determine a plurality of sequence schedules for completing the set of instructions and receive an indication of a sequence schedule selected from the plurality of sequence schedules. In addition, the non-transitory computer-readable medium includes instructions to transmit one or more commands to execute the set of instructions according to the selected sequence schedule.

Depending upon the embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 shows a simplified method for performing experiments according to certain embodiments of the present disclosure.

FIG. 2 shows a simplified system for performing experiments according to certain embodiments of the present disclosure.

FIGS. 3 and 4 show simplified diagrams illustrating various modules for performing experiments according to certain embodiments of the present disclosure.

FIG. 5 shows a simplified method for processing experimental workflows according to certain embodiments of the present disclosure.

FIG. 6 shows simplified diagrams illustrating various modules for processing experimental workflows according to certain embodiments of the present disclosure.

FIG. 7 shows a simplified method for managing experimental requests according to certain embodiments of the present disclosure.

FIG. 8 shows simplified diagrams illustrating various modules for managing experimental requests according to certain embodiments of the present disclosure.

FIG. 9 shows a simplified method for processing experimental requests according to certain embodiments of the present disclosure.

FIG. 10 shows simplified diagrams illustrating various modules for processing experimental requests according to certain embodiments of the present disclosure.

### DETAILED DESCRIPTION OF THE DISCLOSURE

Some embodiments of the present disclosure are directed to performing experiments. More particularly, certain embodiments of the present disclosure provide systems and methods for receiving experimental requests and generating instructions for performing experiments related to the experimental request. Merely by way of example, the present disclosure has been applied to transmitting commands to execute the instructions at remote laboratories. But it would be recognized that the present disclosure has much broader range of applicability.

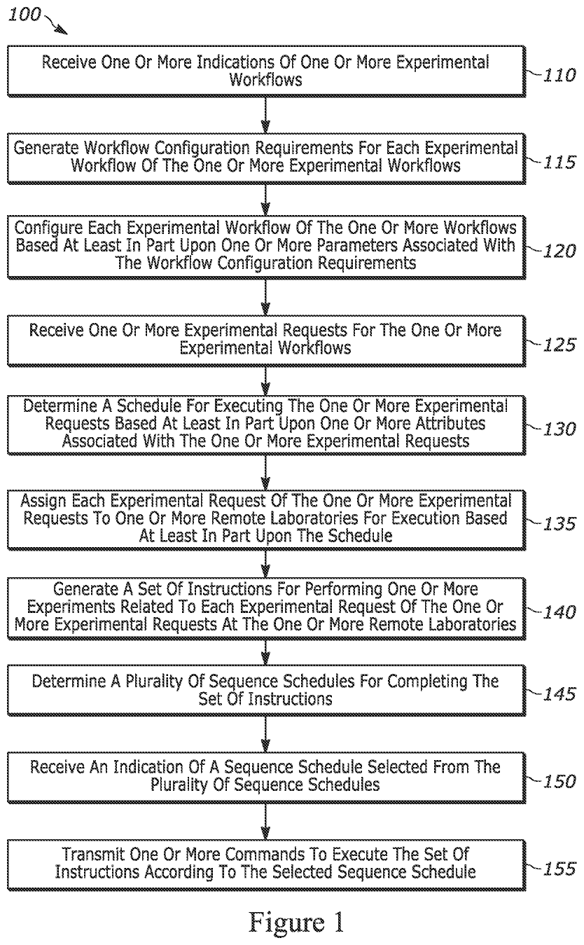

FIG. 1 shows a simplified method for performing experiments according to certain embodiments of the present disclosure. This figure is merely an example, which should not unduly limit the scope of the claims. One of ordinary skill in the art would recognize many variations, alternatives, and modifications. The method 100 includes process 110 for receiving experimental workflows, process 115 for generating workflow configuration requirements, process 120 for configuring experimental workflows, process 125 for receiving experimental requests, process 130 for determining a schedule for the experimental requests, process 135 for assigning the experimental requests, process 140 for generating instructions, process 145 for determining sequence schedules, process 150 for receiving a selected sequence schedule, and process 155 for transmitting commands to execute the instructions. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. For example, some or all processes of the method are performed by a computing device or a processor directed by instructions stored in memory. As an example, some or all processes of the method are performed according to instructions stored in a non-transitory computer-readable medium.

At the process 110, indications of one or more experimental workflows are received according to certain embodiments. In some embodiments, a list of available experimental workflows is published for a user to select. In certain embodiments, the published list is generated based upon user data (e.g., user's access level, user group assignment, etc.) and/or experimental application data (e.g., experiment purpose, intended use, error tolerance, etc.).

At the process 115, workflow configuration requirements for each experimental workflow of the one or more experimental workflows are generated according to certain embodiments. In various embodiments, the workflow configuration requirements include input type entities, data generated, workflow version, and/or published date.

At the process 120, each experimental workflow of the one or more experimental workflows is configured based at least in part upon one or more parameters associated with the workflow configuration requirements according to certain embodiments. In some embodiments, a user interface is provided to enable input of the one or more parameters associated with the workflow configuration requirements. In various embodiments, the user interface is a configurable interface that allows the user to enter the one or more parameters to modify or customize each experimental workflow. For example, the one or more parameters include entities such as volume, comma separated value (CSV) configurations, and/or plate maps. In some embodiments, the user interface provides one or more fields which allow the user to select components from various sources such as laboratory inventory, commercial vendors (e.g., chemical compounds, synthesized materials, reagents, assay kits, etc.), and/or datasets.

In certain embodiments, a validation of the one or more parameters is performed. In some embodiments, performing the validation entails validating the one or more parameters based upon device constraints, experimental constraints, instruction dependencies, and/or experimental design boundaries. In certain embodiments, results from the validation are generated to show detailed steps of each experimental workflow (e.g., cost to execute, estimated time to complete, summary of components, summary of consumables, etc.). In some embodiments, the results may indicate which ones of the one or more parameters were valid and which ones were invalid.

In some embodiments, each configured experimental workflow is transformed into one or more machine executable codes for execution by one or more devices at one or more remote laboratories. In various embodiments, each configured experimental workflow is executed by the one or more devices in accordance with the one or more machine executable codes. For example, the one or more machine executable codes are standardized and reproducible machine executable codes.

In certain embodiments, data (e.g., raw data, labeled data, analyzed data, etc.) generated in or near real-time from the execution of each experimental workflow are collected and stored. The data can be accessed via the user interface and/or through any suitable format (e.g., CSV, JavaScript object notation (JSON), etc.).

In some embodiments, the user interface enables the user to submit at least one configured experimental workflow to a queue for execution. In certain embodiments, the user interface enables the user to request dates for executing the at least one configured experimental workflow. In some embodiments, the user interface enables the user to assign a funding source for the at least one configured experimental workflow.

In certain embodiments, the user interface enables the user to manage the at least one experimental workflow by allowing access to modify user roles, add users, and/or delete users. In some embodiments, the user interface enables the user to manage the at least one experimental workflow by allowing the selection or addition of a remote laboratory for executing the at least one experimental workflow. In certain embodiments, the user interface enables the user to manage the at least one experimental workflow by allowing access to internal/external users, and/or other cloud-based laboratories.

In some embodiments, the user interface updates the status of the at least one experimental workflow in or near real-time. In certain embodiments, the user interface allows the user to view all information associated with the at least one experimental workflow (e.g., status, entered parameters, generated data, data provenance, etc.). In certain embodiments, user inputs received at the user interface and any underlying scripts are used to output human and machine-readable instructions that specify the execution of the at least one experimental workflow.

At the process 125, one or more experimental requests for the one or more experimental workflows are received according to certain embodiments. In some embodiments, one or more attributes associated with the one or more experimental requests are received. For example, the one or more attributes include a target delivery date, a predicted execution duration, human resources needed, robotic resources needed, and/or financial resources needed for each experimental request. In certain embodiments, the one or more attributes are customized per experimental request and/or per customer. In some embodiments, the one or more experimental requests are published along with the status of each experimental request and the one or more attributes associated with each experimental request. In certain embodiments, the one or more experimental requests are published in a prioritized order. In some embodiments, each received experimental request is created using a template.

At the process 130, a schedule for executing the one or more experimental requests based at least in part upon the one or more attributes associated with the one or more experimental requests is determined according to certain embodiments. In some embodiments, the schedule includes an order to execute each experimental request. In certain embodiments, the schedule includes a desired time slot to execute each experimental request.

At the process 135, each experimental request of the one or more experimental requests is assigned to the one or more remote laboratories for execution based at least in part upon the schedule according to certain embodiments. In some embodiments, each experimental request is assigned to the one or more remote laboratories based upon one or more features of the one or more remote laboratories. For example, the one or more features of the one or more remote laboratories include capabilities of the one or more remote laboratories, capacities of the one or more remote laboratories, and/or current workloads at the one or more remote laboratories. As an example, the one or more experimental requests are routed to the one or more remote laboratories based upon the laboratory capabilities, capacities, and/or loads.

In certain embodiments, the user interface is provided to manage (e.g., approve, update, modify, etc.) at least one experimental request. For example, the user interface enables the user to receive information associated with resources needed (e.g., human resources, robotic resources, financial resources, etc.) for at least one experimental request. As an example, the user interface enables the user to receive one or more modifications to the at least one experimental request. For example, the user interface enables the user to place the at least one experiment request in an execution queue. As an example, the user interface enables to user to receive one or more notifications (e.g., experimental request initiated, experimental request completed, etc.).

At the process 140, a set of instructions for performing one or more experiments related to each experimental request of the one or more experimental requests at the one or more remote laboratories are generated according to certain embodiments.

At the process 145, a plurality of sequence schedules for completing the set of instructions are determined according to certain embodiments. In some embodiments, the plurality of sequence schedules are determined based upon various constraints, such as one or more available devices, one or more available materials, one or more estimated durations of executing the set of instructions, one or more optimizations (e.g., minimum execution time, maximum throughput of instructions, maximum device usage, etc.), and one or more experimental constraints (e.g., biological design constraints). In certain embodiments, an optimal sequence schedule is determined based on the various constraints.

At the process 150, an indication of a sequence schedule selected from the plurality of sequence schedules is received according to certain embodiments. In some embodiments, a desired sequence schedule is selected by the user.

At the process 155, one or more commands to execute the set of instructions according to the selected sequence schedule are transmitted according to certain embodiments. In some embodiments, the one or more commands are transmitted to one or more human operators and/or one or more robotic operators to execute the set of instructions according to the selected sequence schedule.

In certain embodiments, information associated with executing the set of instructions according to the selected sequence schedule are collected and transmitted in response to each experimental request of the one or more experimental requests. In various embodiments, the collected information includes environmental variables, device statuses, device feedbacks, and/or human feedbacks.

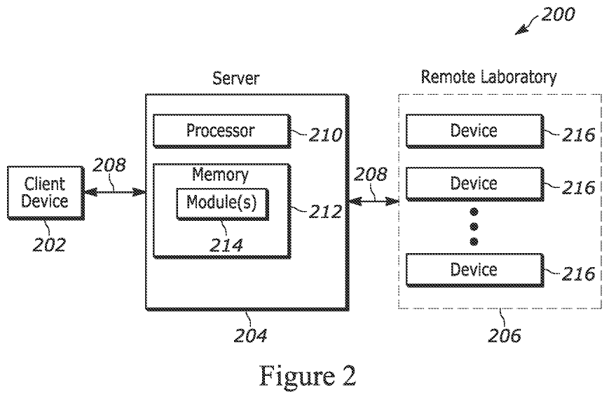

FIG. 2 shows a simplified system for performing experiments according to certain embodiments of the present disclosure. This figure is merely an example, which should not unduly limit the scope of the claims. One of ordinary skill in the art would recognize many variations, alternatives, and modifications. The system 200 includes a client device 202, a server 204 and a remote laboratory 206. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In various embodiments, the client device 202, the server 204, and the remote laboratory 206 are communicatively coupled to one another via a suitable network 208 (e.g., Internet, mobile communication network, virtual private network, local area network, etc.). In some embodiments, the server 204 is part of or located at the remote laboratory 206. In certain embodiments, multiple remote laboratories 206 exist in the system 200.

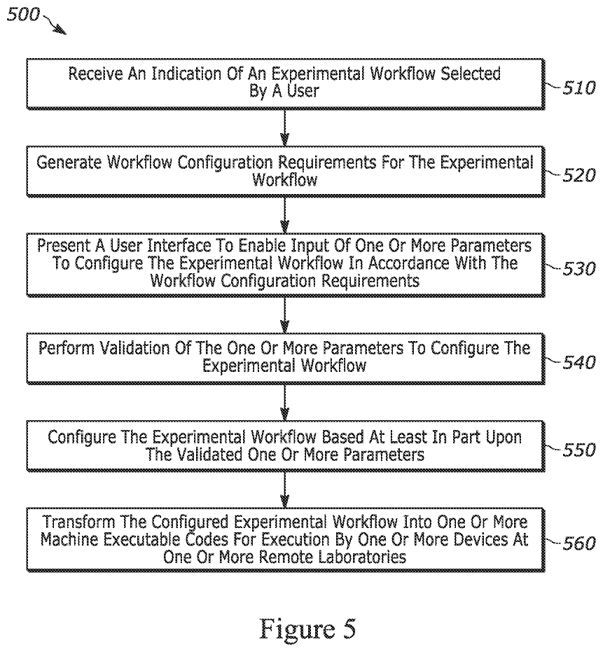

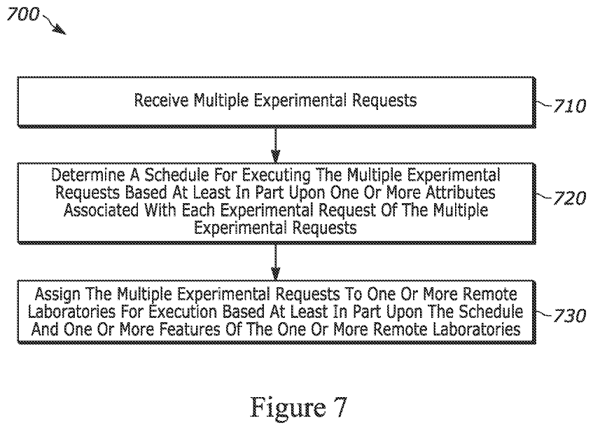

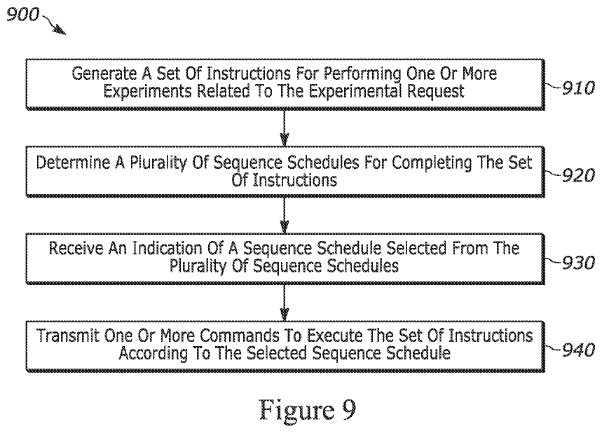

In certain embodiments, a user (e.g., a scientist, a researcher, etc.) may use the client device 202 to communicate with the server 204 for performing experiments at the remote laboratory 206. For example, the server 204 executes one or more operations to implement the method 100 of FIG. 1. In various embodiments, the server 204 may execute one or more operations to implement additional methods, such as the method 500 of FIG. 5, the method 700 of FIG. 7, and/or the method 900 of FIG. 9, as described further below. In some embodiments, the server 204 includes a processor 210 and a memory 212. For example, the processor 210 is configured to execute instructions and/or one or more modules 214 to perform the various operations associated with the method 100 of FIG. 1, the method 500 of FIG. 5, the method 700 of FIG. 7, and/or the method 900 of FIG. 9. As an example, the instructions and the one or more modules 214 are stored in the memory 212.

In some embodiments, the remote laboratory 206 employs one or more devices 216 to execute the experimental workflow. For example, the one or more devices 216 may include acoustic liquid handlers (e.g., Beckman Echo 650/525, EDC Biosystems ATS), polymerase chain reaction (PCR) machines (e.g., Bio-Rad CFX96, Bio-Rad CFX384, Thermo Fisher 7500 RT), centrifuges (e.g., Bionex HiG 4), reagent dispensers (e.g., Thermo Scientific Multidrop, Formulatrix Tempest), magnetic purification processors (e.g., Thermo Scientific KingFisher Flex Magnetic Particle Processor Magnetic Plate Separation), liquid handling devices (e.g., Agilent Bravo 96w/384w, Tecan ADP, Hamilton Star), flow cytometers (e.g., Attune NxT Acoustic Focusing Cytometer), live cell formats (e.g., cell imaging), Next-generation sequencing (NGS) sequencers (e.g., Pacific Biosciences RS II sequencer, Illumina HiSeq 4000 sequencer), analytical chemistry devices (e.g., Agilent LC/MS Infinity II), and/or synthetic chemistry robotics. In various embodiments, the one or more devices 216 can be combined in any number of ways. In some embodiments, a mix of human and/or robotic laboratory services are provided to manage and process experimental workflows at the remote laboratory 206.

In certain embodiments, the system 200 is employed for various scientific applications and/or research areas (e.g., drug discovery, cancer research, protein engineering, synthetic biology, high throughput screening, bio-chemical assays, medicinal chemistry, personalized medicine, and/or closed-loop machine learning applications).

In various embodiments, any variety of machine learning approaches may be performed on data generated in the system 200 to further inform and guide next steps in experimentation, improve performance, create new experiments, and/or analyze data across previously disparate scientific applications.

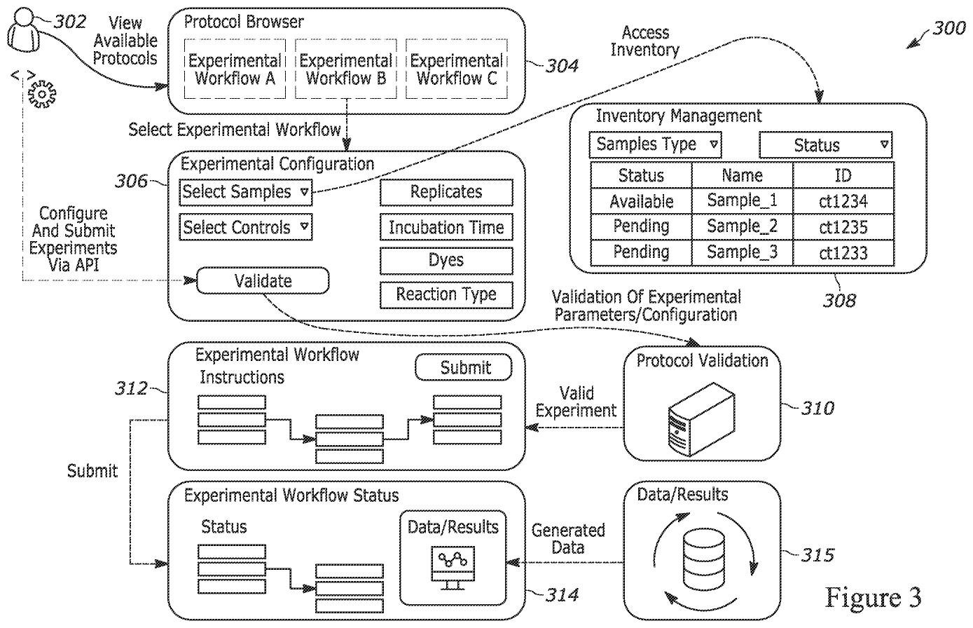

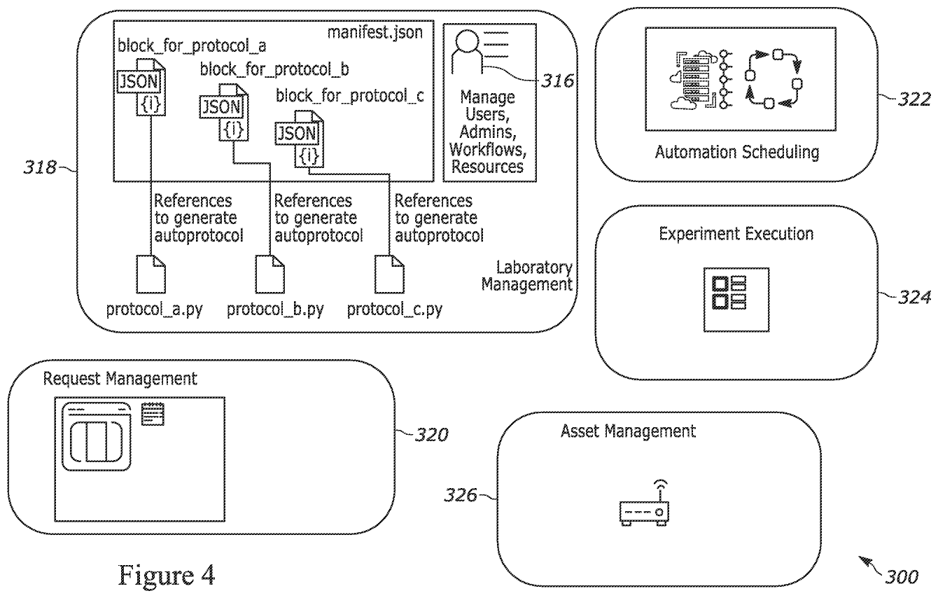

FIGS. 3 and 4 show simplified diagrams of various modules for performing experiments according to certain embodiments of the present disclosure. The figures are merely examples, which should not unduly limit the scope of the claims. One of ordinary skill in the art would recognize many variations, alternatives, and modifications. The system 300 includes a protocol browser module 304, an experimental configuration module 306, an inventory management module 308, a protocol validation module 310, an experimental workflow module 312, an experimental workflow status module 314, a laboratory management module 318, an experimental request management module 320, an automation scheduling module 322, an experiment execution module 324, and an asset management module 326. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In various embodiments, the modules 304-326 are web-based modules. For example, the modules 304-326 are accessible via the Internet. In some embodiments, the modules 304-326 are part of the one or more modules 214 of FIG. 2.

In certain embodiments, the protocol browser module 304 includes functionalities that enable a user 302 (e.g., a scientist) to view information regarding experimental workflows. For example, the user 302 can view available experimental workflows, version controlled experimental workflows, and/or linked execution history of experimental workflows. As an example, the user 302 can select an experimental workflow to execute.

In some embodiments, the experimental configuration module 306 includes functionalities that enable the user 302 to manage experimental workflows. For example, the user 302 can view and manage existing experimental workflows as well as request run submissions for new experimental workflows. As an example, the user 302 can configure the experimental workflow using customizable parameters.

In certain embodiments, the inventory management module 308 includes functionalities that enable the user 302 to perform multi-site management, material management, and/or sample tracking and provenance. For example, the user 302 can virtually select samples (e.g., proprietary/non-proprietary reagents, consumables, vendor supplied samples, biological samples, compounds, custom defined entities, etc.) from the inventory management module 308.

In some embodiments, the protocol validation module 310 includes functionalities that enable the user 302 to perform validation of experimental workflows. For example, the user 302 can validate protocol design parameters and/or other parameters used to configure an experimental workflow. As an example, the user 302 can submit configured experimental workflows with selected parameters and samples for validation.

In certain embodiments, the experimental workflow module 312 includes functionalities that allow the user 302 to monitor the execution of instructions for experimental workflows. In some embodiments, the experimental workflow module 312 includes functionalities that allow the user 302 to submit an experimental workflow to a queue for execution.

In some embodiments, the experimental workflow status module 314 includes functionalities that allow the user 302 to monitor the execution status of experimental workflows. For example, the user 302 can receive notifications/alerts on status changes (e.g., once workflow has started, data generated from the workflow, workflow completed, etc.). In certain embodiments, the experimental workflow status module 314 include functionalities that allow the user 302 to view and/or download generated data/results 315 (e.g., diagnostic data, execution data, and/or other suitable data generated in or near real-time).

In some embodiments, the laboratory management module 318 includes functionalities to that allow a user 316 (e.g., a laboratory administrator) to manage access to the system 300 including granting access to users and/or user groups. In certain embodiments, the user 316 can use the laboratory management module 318 to manage user access policies, user roles, experimental workflows, and/or resources. In some embodiments, the laboratory management module 318 allows the user 316 to add protocols and/or customize pricing models.

In certain embodiments, the experimental request management module 320 includes functionalities that enable the user 316 to manage and/or schedule experimental requests. For example, the user 316 can set schedules (e.g., set a time of execution) and/or overwrite pre-determined schedules. As an example, the user 316 can view, approve/reject, and/or assign an experimental request for execution. In various embodiments, the user 316 uses feedback from the inventory management module 308 (e.g., available samples, available reagents, pending orders, low inventory, etc.) to assign human (e.g., laboratory personnel) and/or robotic resources. In some examples, laboratory personnel can use the experimental request management module 320 to submit experiments for execution and/or schedule experiments for execution with the automation scheduling module 322.

In some embodiments, the automation scheduling module 322 includes functionalities that provide device control, task management, and/or task execution. For example, the automation scheduling module 322 includes an experimental scheduler that plans and organizes various experimental tasks.

In certain embodiments, the experiment execution module 324 includes functionalities to provide detailed experimental steps. For example, the experiment execution module 324 provides detailed steps for execution by human and/or robotic operators. As an example, the experiment execution module 324 coordinates experimental tasks that are executable by various human and/or robotic resources. For example, the experiment execution module 324 returns data, results, metadata, and/or logs captured during experiments.

In some embodiments, the asset management module 326 includes functionalities to control and execute commands on one or more devices and/or create a set of configurable properties (e.g., device configuration) for the one or more devices.

In certain embodiments, the asset management module 326 manages device infrastructure through a suitable interface (e.g., user interface, application programming interface (API), etc.). For example, the asset management module 326 commissions or provisions one or more devices under an edge node or cloud infrastructure. As an example, the asset management module 326 manages the deployment of a device controller for every device in the edge node or cloud infrastructure. For example, the asset management module 326 commands one or more devices to start, stop, restart, etc.

In some embodiments, the asset management module 326 manages the configurations, settings, and/or statuses of devices. In certain example, laboratory personnel can manage devices (e.g., bring devices online, check device health, etc.) as needed by using the asset management module 326.

In certain embodiments, a programmable (software) agent can replace the user 302 in operating the system 300. For example, the programmable agent can use an API to select, configure, submit and/or fetch data. As an example, the programmable agent can receive and process notifications of experiment status change, webhooks, and/or data fetching. In some examples, the programmable agent can use the API to fetch samples available in the inventory management module 308. In certain examples, the programmable agent can use the API to submit parameters to the experimental configuration module 306. In some examples, the programmable agent can use the API to monitor execution status in the experimental workflow status module 314.

FIG. 5 shows a simplified method for processing experimental workflows according to certain embodiments of the present disclosure. This figure is merely an example, which should not unduly limit the scope of the claims. One of ordinary skill in the art would recognize many variations, alternatives, and modifications. The method 500 includes process 510 for receiving an experimental workflow, process 520 for generating experimental workflow requirements, process 530 for presenting a user interface, process 540 for validating parameters, process 550 for configuring the experimental workflow, and process 560 for executing the experimental workflow. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. For example, some or all processes of the method are performed by a computing device or a processor directed by instructions stored in memory. As an example, some or all processes of the method are performed according to instructions stored in a non-transitory computer-readable medium.

At the process 510, an indication of the experimental workflow selected by a user is received according to certain embodiments. In some embodiments, a list of available experimental workflows is published for the user to select. In certain embodiments, the published list is generated based upon user data (e.g., user's access level, user group assignment, etc.) and/or experimental application data (e.g., experiment purpose, intended use, error tolerance, etc.).

At the process 520, workflow configuration requirements for the experimental workflow are generated according to certain embodiments. In some embodiments, the workflow configuration requirements include input type entities, data generated, workflow version, and/or published date.

At the process 530, the user interface is presented to enable input of one or more parameters to configure the experimental workflow according to certain embodiments. In various embodiments, the user interface is a configurable interface that allows the user to enter the one or more parameters to modify or customize the experimental workflow. For example, the one or more parameters include entities such as volume, comma separated value (CSV) configurations, and/or plate maps. In some embodiments, the user interface provides one or more fields which allow the user to select components from various sources such as laboratory inventory, commercial vendors (e.g., chemical compounds, synthesized materials, reagents, assay kits, etc.), and/or datasets.

At the process 540, a validation of the one or more parameters to configure the experimental workflow is performed according to certain embodiments. In some embodiments, performing the validation entails validating the one or more parameters based upon device constraints, experimental constraints, instruction dependencies, and/or experimental design boundaries. In certain embodiments, results from the validation are generated to show detailed steps of the experimental workflow (e.g., cost to execute, estimated time to complete, summary of components, summary of consumables, etc.). In some embodiments, the results may indicate which ones of the one or more parameters were valid and which ones were invalid.

At the process 550, the experimental workflow is configured based upon the validated one or more parameters according to certain embodiments. At the process 560, the configured experimental workflow is transformed into one or more machine executable codes for execution by one or more devices at one or more remote laboratories according to certain embodiments. In various embodiments, the experimental workflow is executed by the one or more devices in accordance with the one or more machine executable codes. For example, the one or more machine executable codes are standardized and reproducible machine executable codes.

In some embodiments, data (e.g., raw data, labeled data, analyzed data, etc.) generated in or near real-time from the execution of the experimental workflow are collected and stored. The data can be accessed via the user interface and/or through any suitable format (e.g., CSV, JavaScript object notation (JSON), etc.).

In certain embodiments, the user interface enables the user to submit the configured experimental workflow to a queue for execution. In some embodiments, the user interface enables the user to request dates for executing the configured experimental workflow. In certain embodiments, the user interface enables the user to assign a funding source for the configured experimental workflow.

In certain embodiments, the user interface enables the user to manage the experimental workflow by allowing access to experimental intent packages. For example, the user interface publishes the experimental intent packages to user groups. As an example, the user interface allows experimental intent scripts available to specified users to be collected. For example, the user interface displays user groups and defined roles for the users.

In some embodiments, the user interface enables the user to manage the experimental workflow by allowing access to modify user roles, add users, and/or delete users associated with the experimental workflow. In certain embodiments, the user interface enables the user to manage the experimental workflow by allowing the selection or addition of a remote laboratory for executing the experimental workflow. In some embodiments, the user interface enables the user to manage the experimental workflow by allowing access to internal/external users, and/or other cloud-based laboratories.

In certain embodiments, the user interface updates the status of the experimental workflow in or near real-time. In some embodiments, the user interface allows the user to view all information associated with the experimental workflows (e.g., status, entered parameters, generated data, data provenance, etc.).

In some embodiments, user inputs received at the user interface and any underlying scripts are used to output human and machine-readable instructions that specify the execution of the experimental workflow.

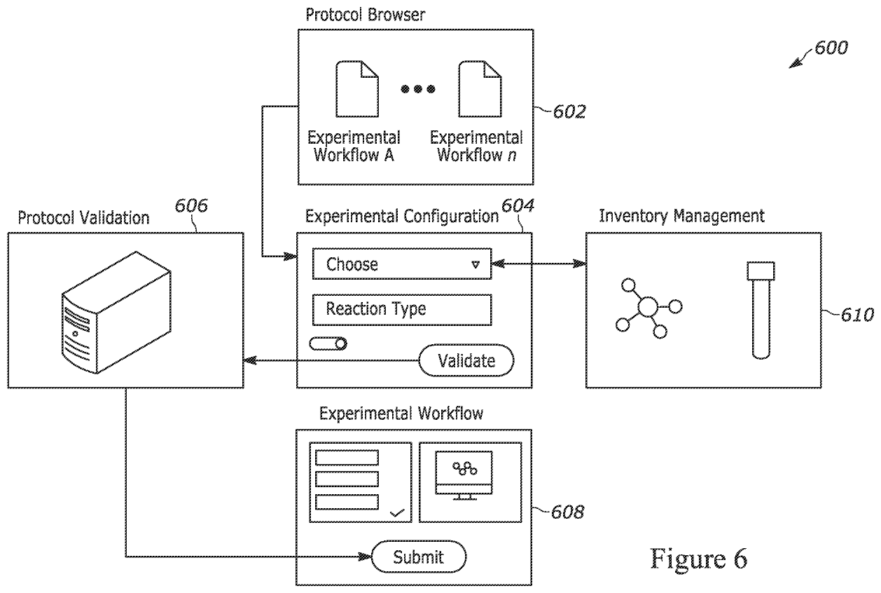

FIG. 6 shows a simplified diagram of various modules for processing experimental workflows according to certain embodiments of the present disclosure. This figure is merely an example, which should not unduly limit the scope of the claims. One of ordinary skill in the art would recognize many variations, alternatives, and modifications. The system 600 includes a protocol browser module 602, an experimental configuration module 604, a protocol validation module 606, an experimental workflow module 608, and an inventory management module 610. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In various embodiments, one or more processes are executed by the modules 602-610 for selecting, configuring, submitting, and/or tracking experimental workflows at one or more remote laboratories.

In certain embodiments, the protocol browser module 602, the experimental configuration module 604, the protocol validation module 606, the experimental workflow module 608, and/or the inventory management module 610 are web-based modules. For example, the modules 602-610 are accessible via the Internet. In some embodiments, the modules 602-610 are part of the one or more modules 214 of FIG. 2.

In some embodiments, the protocol browser module 602 includes functionalities that enable a user to view information regarding experimental workflows. For example, the user can view available experimental workflows, version controlled experimental workflows, and/or linked execution history of experimental workflows. In various embodiments, the protocol browser module 602 includes functionalities that allow the user to customize inputs, parameters, and/or validations.

In certain embodiments, the experimental configuration module 604 includes functionalities that enable the user to manage experimental workflows. For example, the user can view and manage existing experimental workflows as well as request run submissions for new experimental workflows. In some embodiments, the experimental configuration module 604 includes functionalities that allow the user to define protocol design parameters. As an example, the user can configure parameters in an experimental workflow. In certain embodiments, the experimental configuration module 604 includes functionalities that allow the user to access an inventory for sample selection.

In some embodiments, the protocol validation module 606 includes functionalities that enable the user to perform validation of experimental workflows. For example, the user can validate protocol design parameters and/or other parameters used to configure an experimental workflow.

In certain embodiments, the experimental workflow module 608 includes functionalities that allow the user to monitor the execution status of instructions for experimental workflows. In some embodiments, the experimental workflow module 608 includes functionalities that allow the user to view and download data, such as diagnostic data, execution data, and/or other generated data in or near real-time. In various embodiments, the experimental configuration module 604 and/or the experimental workflow module 608 provide API endpoints.

In some embodiments, the inventory management module 610 includes functionalities that enable the user to perform multi-site management, material management, and/or sample tracking and provenance.

FIG. 7 shows a simplified method for managing experimental requests according to certain embodiments of the present disclosure. This figure is merely an example, which should not unduly limit the scope of the claims. One of ordinary skill in the art would recognize many variations, alternatives, and modifications. The method 700 includes process 710 for receiving experimental requests, process 720 for scheduling the experimental requests, and process 730 for assigning the experimental requests for execution. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. For example, some or all processes of the method are performed by a computing device or a processor directed by instructions stored in memory. As an example, some or all processes of the method are performed according to instructions stored in a non-transitory computer-readable medium.

At the process 710, multiple experimental requests are received according to certain embodiments. In some embodiments, one or more attributes associated with each experimental request are received. For example, the one or more attributes include a target delivery date, a predicted execution duration, human resources needed, robotic resources needed, and/or financial resources needed. In certain embodiments, the one or more attributes are customized per experimental request and/or per customer. In some embodiments, the multiple experimental requests are published along with the status of each experimental request and the one or more attributes associated with each experimental request. In certain embodiments, the multiple experimental requests are published in a prioritized order. In some embodiments, each received experimental request is created using a template.

At the process 720, a schedule for executing the multiple experimental requests based at least in part upon the one or more attributes associated with each experimental request is determined according to certain embodiments. In some embodiments, the schedule includes an order to execute each experimental request. In certain embodiments, the schedule includes a desired time slot to execute each experimental request.

At the process 730, the multiple experimental requests are assigned to one or more remote laboratories for execution based at least in part upon the schedule and one or more features of the one or more remote laboratories according to certain embodiments. In some embodiments, the one or more features of the one or more remote laboratories include capabilities of the one or more remote laboratories, capacities of the one or more remote laboratories, and/or current workloads at the one or more remote laboratories. For example, the multiple experimental requests are routed to the one or more remote laboratories based upon the laboratory capabilities, capacities, and/or loads.

In certain embodiments, a user interface is provided to manage (e.g., approve, update, modify, etc.) at least one experimental request of the multiple experimental requests. For example, the user interface is configured to send one or more notifications (e.g., experimental request initiated, experimental request completed, etc.) to a submitter of the at least one experimental request. As an example, the user interface is configured to receive, from the submitter of the at least one experimental request, information associated with resources needed (e.g., human resources, robotic resources, financial resources, etc.) for the at least one experimental request. For example, the user interface is configured to receive, from the submitter of the at least one experimental request, one or more modifications to the at least one experimental request. As an example, the user interface is configured to enable the submitter to place the at least one experiment request in an execution queue.

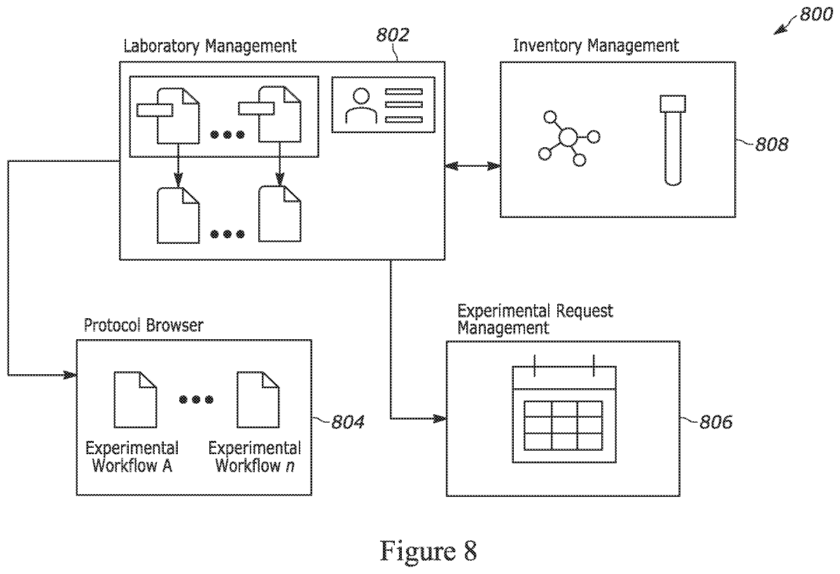

FIG. 8 shows a simplified diagram of various modules for managing experimental requests according to certain embodiments of the present disclosure. This figure is merely an example, which should not unduly limit the scope of the claims. One of ordinary skill in the art would recognize many variations, alternatives, and modifications. The system 800 includes a laboratory management module 802, a protocol browser module 804, an experimental request management module 806, and an inventory management module 808. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In various embodiments, one or more processes are executed by the modules 802-808 for coordinating, planning, scheduling, and/or allocating resources to experimental requests at one or more remote laboratories.

In certain embodiments, the laboratory management module 802, the protocol browser module 804, the experimental request management module 806, and/or the inventory management module 808 are web-based modules. For example, the modules 802-808 are accessible via the Internet. In some embodiments, the modules 802-808 are part of the one or more modules 214 of FIG. 2.

In some embodiments, the laboratory management module 802 includes functionalities to manage users (e.g., add users, delete users, define user groups, etc.) and user roles (e.g., user scope, user access, etc.). In certain embodiments, user roles are customized based upon organization requirements. In some embodiments, the laboratory management module 802 allows a user to add remote laboratories. For example, the user can add a remote laboratory for executing experimental requests available to users or user groups. In certain embodiments, the laboratory management module 802 allows the user to add protocols and/or customize pricing models. In certain embodiments, the laboratory management module 802 receives experimental requests and publishes experimental workflow associated with the experimental requests.

In various embodiments, the laboratory management module 802 manages user access policies, user groups, and/or user roles. In some embodiments, the laboratory management module 802 allows secured access of data based upon a permission model. In certain embodiments, the permission model enables collaboration for sharing of scientific knowledge gained through running experiments across remote laboratories.

In some embodiments, the protocol browser module 804 includes functionalities that enable the user to view information regarding the experimental workflows. For example, the user can view available experimental workflows, version controlled experimental workflows, and/or linked execution history of experimental workflows. In various embodiments, the protocol browser module 802 includes functionalities that allow the user to customize inputs, parameters, and/or validations.

In certain embodiments, the experimental request management module 806 includes functionalities that enable the user to manage and/or schedule the experiment requests. For example, the user can view, approve/reject, and/or assign the experimental requests for execution. In various embodiments, the experimental request management module 806 includes functionalities to assign human, robotic and/or financial resources.

In some embodiments, the inventory management module 808 includes functionalities that enable the user to perform multi-site management, material management, and/or sample tracking and provenance.

FIG. 9 shows a simplified method for managing experimental requests according to certain embodiments of the present disclosure. This figure is merely an example, which should not unduly limit the scope of the claims. One of ordinary skill in the art would recognize many variations, alternatives, and modifications. The method 900 includes process 910 for generating instructions, process 920 for determining sequence schedules, process 930 for receiving a selected sequence schedule, and process 940 for transmitting commands to execute the instructions. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. For example, some or all processes of the method are performed by a computing device or a processor directed by instructions stored in memory. As an example, some or all processes of the method are performed according to instructions stored in a non-transitory computer-readable medium.

At the process 910, a set of instructions for performing one or more experiments related to an experimental request are generated according to certain embodiments. In some embodiments, the experimental request is received from a submitter and processed to generate the set of instructions.

At the process 920, a plurality of sequence schedules for completing the set of instructions are determined according to certain embodiments. In some embodiments, the plurality of sequence schedules are determined based upon various constraints, such as one or more available devices, one or more available materials, one or more estimated durations of executing the set of instructions, one or more optimizations (e.g., minimum execution time, maximum throughput of instructions, maximum device usage, etc.), and one or more experimental constraints (e.g., biological design constraints). In certain embodiments, an optimal sequence schedule is determined based on the various constraints.

At the process 930, an indication of a sequence schedule selected from the plurality of sequence schedules is received according to certain embodiments. In some embodiments, a desired sequence schedule is selected by the submitter of the experimental request.

At the process 940, one or more commands to execute the set of instructions according to the selected sequence schedule are transmitted according to certain embodiments. In some embodiments, the one or more commands are transmitted to one or more human operators to execute the set of instructions according to the selected sequence schedule. In certain embodiments, the one or more commands are transmitted to one or more robotic operators to execute the set of instructions according to the selected sequence schedule. In some embodiments, the one or more commands are transmitted to one or more human operators and one or more robotic operators to execute the set of instructions according to the selected sequence schedule.

In certain embodiments, information associated with executing the set of instructions according to the selected sequence schedule are collected and transmitted in response to the experimental request. In various embodiments, the collected information includes environmental variables, device statuses, device feedbacks, and/or human feedbacks.

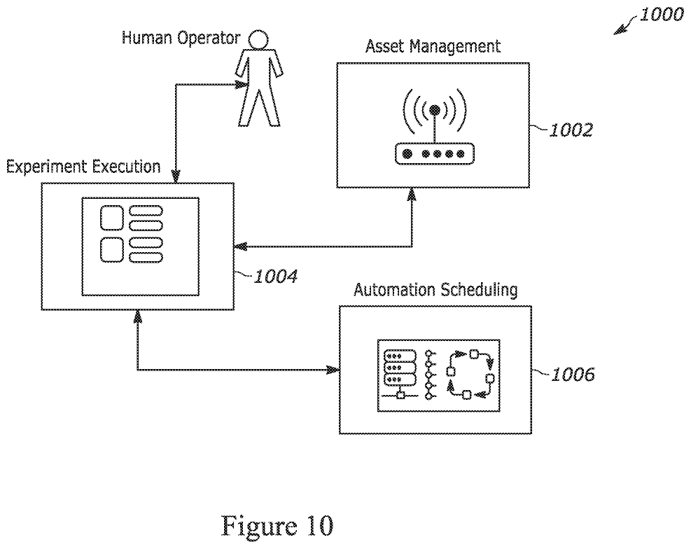

FIG. 10 shows a simplified diagram of various modules for processing experimental requests according to certain embodiments of the present disclosure. This figure is merely an example, which should not unduly limit the scope of the claims. One of ordinary skill in the art would recognize many variations, alternatives, and modifications. The system 1000 includes an asset management module 1002, an experiment execution module 1004, and an automation scheduling module 1006. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In various embodiments, one or more processes are executed by the modules 1002-1006 for scheduling, sequencing, optimizing, and/or performing steps in an experimental request executed at one or more remote laboratories.

In certain embodiments, the asset management module 1002, the experiment execution module 1004, and/or the automation scheduling module 1006 are web-based modules. For example, the modules 1002-1006 are accessible via the Internet. In some embodiments, the modules 1002-1006 are part of the one or more modules 214 of FIG. 2.

In some embodiments, the asset management module 1002 includes functionalities to provide a driver and/or data uploader. In various embodiments, the asset management module 1002 is able to control and execute commands on one or more devices and/or create a set of configurable properties (e.g., device configuration) for the one or more devices.

In certain embodiments, the asset management module 1002 manages device infrastructure through a suitable interface (e.g., user interface, application programming interface, etc.). For example, the asset management module 1002 commissions or provisions one or more devices under an edge node or cloud infrastructure. As an example, the asset management module 1002 manages the deployment of a device controller for every device in the edge node or cloud infrastructure. For example, the asset management module 1002 commands one or more devices to start, stop, restart, etc.

In some embodiments, the asset management module 1002 manages the configurations/settings of a device (e.g., laboratory specific configurations as required by operations or experimental constraints). For example, the asset management module 1002 allows a user (e.g., human operator) to view the configurations/settings of the device, and/or edit the configurations/settings of the device. As an example, the configurations/settings of the device are updated to the device in real-time. For example, the configurations/settings of the device are versioned and tracked to leave a configuration audit trail.

In certain embodiments, the asset management module 1002 monitors the status of the device. For example, the asset management module 1002 allows the user to monitor and view real-time status updates, connection statuses, and/or device health. As an example, the asset management module 1002 allows the user to monitor and view real-time updates of the connection status of the device to the device controller.

In some embodiments, the asset management module 1002 trains and configures the device remotely. For example, the device may be a robotic device that requires waypoint training (e.g., a Precise Flex robotic arm). As an example, the robotic device can be trained and configured remotely by the asset management module 1002. For example, there are no limitations on how many devices can be trained at any given time.

In certain embodiments, the experiment execution module 1004 includes functionalities to provide detailed experimental steps. For example, the experiment execution module 1004 provides detailed steps for execution by human and/or robotic operators.

In some embodiments, the automation scheduling module 1006 includes functionalities that provide device control, task management, and/or task execution. In certain embodiments, the automation scheduling module 1006 provides functionalities that enable the user to define scientific constraints from protocols.

According to certain embodiments, a method for performing one or more experiments includes receiving one or more indications of one or more experimental workflows and generating workflow configuration requirements for each experimental workflow of the one or more experimental workflows. Also, the method includes configuring each experimental workflow of the one or more experimental workflows based at least in part upon one or more parameters associated with the workflow configuration requirements. Further, the method includes receiving one or more experimental requests for the one or more experimental workflows and determining a schedule for executing the one or more experimental requests based at least in part upon one or more attributes associated with the one or more experimental requests. Moreover, the method includes assigning each experimental request of the one or more experimental requests to one or more remote laboratories for execution based at least in part upon the schedule. Also, the method includes generating a set of instructions for performing one or more experiments related to each experimental request of the one or more experimental requests at the one or more remote laboratories. Further, the method includes determining a plurality of sequence schedules for completing the set of instructions and receiving an indication of a sequence schedule selected from the plurality of sequence schedules. In addition, the method includes transmitting one or more commands to execute the set of instructions according to the selected sequence schedule. For example, the method is implemented according to at least FIG. 1.

According to some embodiments, a system for performing one or more experiments includes one or more processors and a memory storing instructions for execution by the one or more processors. The instructions, when executed by the one or more processors, cause the system to receive one or more indications of one or more experimental workflows and generate workflow configuration requirements for each experimental workflow of the one or more experimental workflows. Also, the instructions, when executed by the one or more processors, cause the system to configure each experimental workflow of the one or more experimental workflows based at least in part upon one or more parameters associated with the workflow configuration requirements. Further, the instructions, when executed by the one or more processors, cause the system to receive one or more experimental requests for the one or more experimental workflows and determine a schedule for executing the one or more experimental requests based at least in part upon one or more attributes associated with the one or more experimental requests. Moreover, the instructions, when executed by the one or more processors, cause the system to assign each experimental request of the one or more experimental requests to one or more remote laboratories for execution based at least in part upon the schedule. Also, the instructions, when executed by the one or more processors, cause the system to generate a set of instructions for performing one or more experiments related to each experimental request of the one or more experimental requests at the one or more remote laboratories. Further, the instructions, when executed by the one or more processors, cause the system to determine a plurality of sequence schedules for completing the set of instructions and receive an indication of a sequence schedule selected from the plurality of sequence schedules. In addition, the instructions, when executed by the one or more processors, cause the system to transmit one or more commands to execute the set of instructions according to the selected sequence schedule. For example, the system is implemented according to at least FIG. 2.

According to certain embodiments, a non-transitory computer-readable medium stores instructions for performing one or more experiments. The instructions are executed by one or more processors of a computing device. The non-transitory computer-readable medium includes instructions to receive one or more indications of one or more experimental workflows and generate workflow configuration requirements for each experimental workflow of the one or more experimental workflows. Also, the non-transitory computer-readable medium includes instructions to configure each experimental workflow of the one or more experimental workflows based at least in part upon one or more parameters associated with the workflow configuration requirements. Further, the non-transitory computer-readable medium includes instructions to receive one or more experimental requests for the one or more experimental workflows and determine a schedule for executing the one or more experimental requests based at least in part upon one or more attributes associated with the one or more experimental requests. Moreover, the non-transitory computer-readable medium includes instructions to assign each experimental request of the one or more experimental requests to one or more remote laboratories for execution based at least in part upon the schedule. Also, the non-transitory computer-readable medium includes instructions to generate a set of instructions for performing one or more experiments related to each experimental request of the one or more experimental requests at the one or more remote laboratories. Further, the non-transitory computer-readable medium includes instructions to determine a plurality of sequence schedules for completing the set of instructions and receive an indication of a sequence schedule selected from the plurality of sequence schedules. In addition, the non-transitory computer-readable medium includes instructions to transmit one or more commands to execute the set of instructions according to the selected sequence schedule. For example, the non-transitory computer-readable medium is implemented according to at least FIG. 1, FIG. 2, FIG. 3, and/or FIG. 4.

According to certain embodiments, a method for processing one or more experimental workflows includes receiving an indication of an experimental workflow selected by a user. Also, the method includes generating workflow configuration requirements for the experimental workflow. Further, the method includes presenting a user interface to enable input of one or more parameters to configure the experimental workflow in accordance with the workflow configuration requirements. Moreover, the method includes performing a validation of the one or more parameters to configure the experimental workflow and configuring the experimental workflow based at least in part upon the validated one or more parameters. In addition, the method includes transforming the configured experimental workflow into one or more machine executable codes for execution by one or more devices at one or more remote laboratories. For example, the method is implemented according to at least FIG. 5.

According to some embodiments, a system for processing one or more experimental workflows includes one or more processors and a memory storing instructions for execution by the one or more processors. The instructions, when executed by the one or more processors, cause the system to receive an indication of an experimental workflow selected by a user. Also, the instructions, when executed by the one or more processors, cause the system to generate workflow configuration requirements for the experimental workflow. Further, the instructions, when executed by the one or more processors, cause the system to present a user interface to enable input of one or more parameters to configure the experimental workflow in accordance with the workflow configuration requirements. Moreover, the instructions, when executed by the one or more processors, cause the system to perform a validation of the one or more parameters to configure the experimental workflow and configure the experimental workflow based at least in part upon the validated one or more parameters. In addition, the instructions, when executed by the one or more processors, cause the system to transform the configured experimental workflow into one or more machine executable codes for execution by one or more devices at one or more remote laboratories. For example, the system is implemented according to at least FIG. 2.

According to certain embodiments, a non-transitory computer-readable medium stores instructions for processing one or more experimental workflows. The instructions are executed by one or more processors of a computing device. The non-transitory computer-readable medium includes instructions to receive an indication of an experimental workflow selected by a user. Also, the non-transitory computer-readable medium includes instructions to generate workflow configuration requirements for the experimental workflow. Further, the non-transitory computer-readable medium includes instructions to present a user interface to enable input of one or more parameters to configure the experimental workflow in accordance with the workflow configuration requirements. Moreover, the non-transitory computer-readable medium includes instructions to perform a validation of the one or more parameters to configure the experimental workflow and configure the experimental workflow based at least in part upon the validated one or more parameters. In addition, the non-transitory computer-readable medium includes instructions to transform the configured experimental workflow into one or more machine executable codes for execution by one or more devices at one or more remote laboratories. For example, the non-transitory computer-readable medium is implemented according to at least FIG. 2, FIG. 5, and/or FIG. 6.

According to certain embodiments, a method for managing one or more experimental requests includes receiving multiple experimental requests. Also, the method includes determining a schedule for executing the multiple experimental requests based at least in part upon one or more attributes associated with each experimental request of the multiple experimental requests. Moreover, the method includes assigning the multiple experimental requests to one or more remote laboratories for execution based at least in part upon the schedule and one or more features of the one or more remote laboratories. For example, the method is implemented according to at least FIG. 7.

According to some embodiments, a system for managing one or more experimental requests includes one or more processors and a memory storing instructions for execution by the one or more processors. The instructions, when executed by the one or more processors, cause the system to receive multiple experimental requests. Also, the instructions, when executed by the one or more processors, cause the system to determine a schedule for executing the multiple experimental requests based at least in part upon one or more attributes associated with each experimental request of the multiple experimental requests. Moreover, the instructions, when executed by the one or more processors, cause the system to assign the multiple experimental requests to one or more remote laboratories for execution based at least in part upon the schedule and one or more features of the one or more remote laboratories. For example, the system is implemented according to at least FIG. 2.

According to certain embodiments, a non-transitory computer-readable medium stores instructions for managing one or more experimental requests. The instructions are executed by one or more processors of a computing device. The non-transitory computer-readable medium includes instructions to receive multiple experimental requests. Also, the non-transitory computer-readable medium includes instructions to determine a schedule for executing the multiple experimental requests based at least in part upon one or more attributes associated with each experimental request of the multiple experimental requests. Moreover, the non-transitory computer-readable medium includes instructions to assign the multiple experimental requests to one or more remote laboratories for execution based at least in part upon the schedule and one or more features of the one or more remote laboratories. For example, the non-transitory computer-readable medium is implemented according to at least FIG. 2, FIG. 7, and/or FIG. 8.

According to certain embodiments, a method for processing an experimental request includes generating a set of instructions for performing one or more experiments related to the experimental request. Also, the method includes determining a plurality of sequence schedules for completing the set of instructions. Further, the method includes receiving an indication of a sequence schedule selected from the plurality of sequence schedules. Moreover, the method includes transmitting one or more commands to execute the set of instructions according to the selected sequence schedule. For example, the method is implemented according to at least FIG. 9.

According to some embodiments, a system for processing an experimental request includes one or more processors and a memory storing instructions for execution by the one or more processors. The instructions, when executed by the one or more processors, cause the system to generate a set of instructions for performing one or more experiments related to the experimental request. Also, the instructions, when executed by the one or more processors, cause the system to determine a plurality of sequence schedules for completing the set of instructions. Further, the instructions, when executed by the one or more processors, cause the system to receive an indication of a sequence schedule selected from the plurality of sequence schedules. Moreover, the instructions, when executed by the one or more processors, cause the system to transmit one or more commands to execute the set of instructions according to the selected sequence schedule. For example, the system is implemented according to at least FIG. 2.

According to certain embodiments, a non-transitory computer-readable medium stores instructions for processing an experimental request. The instructions are executed by one or more processors of a computing device. The non-transitory computer-readable medium includes instructions to generate a set of instructions for performing one or more experiments related to the experimental request. Also, the non-transitory computer-readable medium includes instructions to determine a plurality of sequence schedules for completing the set of instructions. Further, the non-transitory computer-readable medium includes instructions to receive an indication of a sequence schedule selected from the plurality of sequence schedules. Moreover, the non-transitory computer-readable medium includes instructions to transmit one or more commands to execute the set of instructions according to the selected sequence schedule. For example, the non-transitory computer-readable medium is implemented according to at least FIG. 2, FIG. 9, and/or FIG. 10.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In still another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Certain implementations may also be used, however, such as firmware or even appropriately designed hardware configured to perform the methods and systems described herein.

The systems' and methods' data (e.g., associations, mappings, data input, data output, intermediate data results, final data results) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the present disclosure is not to be limited by the specific illustrated embodiments.

What is claimed is:

1. A method for performing one or more experiments, the method comprising:
receiving one or more indications of one or more experimental workflows;
generating workflow configuration requirements for each experimental workflow of the one or more experimental workflows;
configuring each experimental workflow of the one or more experimental workflows based at least in part upon one or more parameters associated with the workflow configuration requirements;
receiving one or more experimental requests for the one or more experimental workflows;
determining a schedule for executing the one or more experimental requests based at least in part upon one or more attributes associated with the one or more experimental requests;
assigning each experimental request of the one or more experimental requests to one or more remote laboratories for execution based at least in part upon the schedule;
generating a set of instructions for performing one or more experiments related to each experimental request of the one or more experimental requests at the one or more remote laboratories;
determining a plurality of sequence schedules for completing the set of instructions;
receiving an indication of a sequence schedule selected from the plurality of sequence schedules; and
transmitting one or more commands to execute the set of instructions according to the selected sequence schedule.

2. The method of claim 1, further comprising:
providing a user interface to enable input of the one or more parameters associated with the workflow configuration requirements; and
performing a validation of the one or more parameters.

3. The method of claim 2, wherein performing the validation of the one or more parameters includes validating the one or more parameters based at least in part upon at least one selected from a group consisting of a device constraint, an experimental constraint, an instruction dependency, and an experimental design boundary.

4. The method of claim 2, wherein providing the user interface further includes:
enabling a user to submit at least one configured experimental workflow to a queue for execution;
enabling the user to request dates for executing the at least one configured experimental workflow; and
enabling the user to assign a funding source for the at least one configured experimental workflow.

5. The method of claim 2, wherein providing the user interface further includes:
enabling a user to receive information associated with human resources needed and robotic resources needed for at least one experimental request; and
enabling the user to receive one or more modifications to the at least one experimental request.

6. The method of claim 1, further comprising:
collecting information associated with executing the set of instructions according to the selected sequence schedule; and
transmitting the collected information in response to each experimental request of the one or more experimental requests.

7. The method of claim 1, wherein transmitting the one or more commands to execute the set of instructions includes:
transmitting, to one or more human operators and one or more robotic operators, the one or more commands to execute the set of instructions according to the selected sequence schedule.

8. A system for performing one or more experiments, the system comprising:
one or more processors; and
a memory storing instructions that, when executed by the one or more processors, cause the system to:
receive one or more indications of one or more experimental workflows;
generate workflow configuration requirements for each experimental workflow of the one or more experimental workflows;
configure each experimental workflow of the one or more experimental workflows based at least in part upon one or more parameters associated with the workflow configuration requirements;
receive one or more experimental requests for the one or more experimental workflows;
determine a schedule for executing the one or more experimental requests based at least in part upon one or more attributes associated with the one or more experimental requests;
assign each experimental request of the one or more experimental requests to one or more remote laboratories for execution based at least in part upon the schedule;
generate a set of instructions for performing one or more experiments related to each experimental request of the one or more experimental requests at the one or more remote laboratories;
determine a plurality of sequence schedules for completing the set of instructions;
receive an indication of a sequence schedule selected from the plurality of sequence schedules; and
transmit one or more commands to execute the set of instructions according to the selected sequence schedule.

9. The system of claim 8, wherein the instructions, when executed by the one or more processors, further cause the system to:
provide a user interface to enable input of the one or more parameters associated with the workflow configuration requirements; and
perform a validation of the one or more parameters.

10. The system of claim 9, wherein, the instructions that cause the system to perform the validation of the one or more parameters further comprise instructions that cause the system to validate the one or more parameters based at least in part upon at least one selected from a group consisting of a device constraint, an experimental constraint, an instruction dependency, and an experimental design boundary.

11. The system of claim 9, wherein, the instructions that cause the system to provide the user interface further comprise instructions that cause the system to:
enable a user to submit at least one configured experimental workflow to a queue for execution;
enable the user to request dates for executing the at least one configured experimental workflow; and
enable the user to assign a funding source for the at least one configured experimental workflow.

12. The system of claim 9, wherein, the instructions that cause the system to provide the user interface further comprise instructions that cause the system to:
enable a user to receive information associated with human resources needed and robotic resources needed for at least one experimental request; and
enable the user to receive one or more modifications to the at least one experimental request.

13. The system of claim 8, wherein the instructions, when executed by the one or more processors, further cause the system to:
collect information associated with executing the set of instructions according to the selected sequence schedule; and
transmit the collected information in response to each experimental request of the one or more experimental requests.

14. The system of claim 8, wherein, the instructions that cause the system to transmit the one or more commands to execute the set of instructions further comprise instructions that cause the system to transmit, to one or more human operators and one or more robotic operators, the one or more commands to execute the set of instructions according to the selected sequence schedule.

15. A non-transitory computer-readable medium storing instructions for performing one or more experiments, the instructions when executed by one or more processors of a computing device, cause the computing device to:
receive one or more indications of one or more experimental workflows;
generate workflow configuration requirements for each experimental workflow of the one or more experimental workflows;
configure each experimental workflow of the one or more experimental workflows based at least in part upon one or more parameters associated with the workflow configuration requirements;
receive one or more experimental requests for the one or more experimental workflows;
determine a schedule for executing the one or more experimental requests based at least in part upon one or more attributes associated with the one or more experimental requests;
assign each experimental request of the one or more experimental requests to one or more remote laboratories for execution based at least in part upon the schedule;
generate a set of instructions for performing one or more experiments related to each experimental request of the one or more experimental requests at the one or more remote laboratories;
determine a plurality of sequence schedules for completing the set of instructions;
receive an indication of a sequence schedule selected from the plurality of sequence schedules; and
transmit one or more commands to execute the set of instructions according to the selected sequence schedule.

16. The non-transitory computer-readable medium of claim 15, wherein, the instructions when executed by the one or more processors further cause the computing device to:
provide a user interface to enable input of the one or more parameters associated with the workflow configuration requirements; and
perform a validation of the one or more parameters.

17. The non-transitory computer-readable medium of claim 16, wherein, the instructions when executed by the one or more processors that cause the computing device to provide the user interface further cause the computing device to:
enable a user to submit at least one configured experimental workflow to a queue for execution;
enable the user to request dates for executing the at least one configured experimental workflow; and
enable the user to assign a funding source for the at least one configured experimental workflow.

18. The non-transitory computer-readable medium of claim 16, wherein, the instructions when executed by the one or more processors that cause the computing device to provide the user interface further cause the computing device to:
enable a user to receive information associated with human resources needed and robotic resources needed for at least one experimental request; and
enable the user to receive one or more modifications to the at least one experimental request.

19. The non-transitory computer-readable medium of claim 15, wherein, the instructions when executed by the one or more processors further cause the computing device to:
collect information associated with executing the set of instructions according to the selected sequence schedule; and
transmit the collected information in response to each experimental request of the one or more experimental requests.

20. The non-transitory computer-readable medium of claim 15, wherein, the instructions when executed by the one or more processors that cause the computing device to transmit the one or more commands to execute the set of instructions further cause the computing device to transmit, to one or more human operators and one or more robotic operators, the one or more commands to execute the set of instructions according to the selected sequence schedule.
